(19) United States
(12) Patent Application Publication
(10) Pub. No.: US 2012/0195369 A1
(43) Pub. Date: Aug. 2, 2012

(54) ADAPTIVE BIT RATE CONTROL BASED ON SCENES

(75) Inventor: Rodolfo Vargas Guerrero, Palo Alto, CA (US)

(73) Assignee: Eye IO, LLC, Palo Alto, CA (US)

(21) Appl. No.: 13/358,877

(22) Filed: Jan. 26, 2012

Related U.S. Application Data
(60) Provisional application No. 61/437,193, filed on Jan. 28, 2011.
(60) Provisional application No. 61/437,223, filed on Jan. 28, 2011.

(51) Int. Cl. H04N 7/26

(52) U.S. Cl. 375/240.02; 375/E07.126

(57) ABSTRACT

An encoder for encoding a video stream is described herein. The encoder receives an input video stream, scene boundary information that indicates positions n the input video stream where scene transitions occur and target bit rate for each scene. The encoder divides the input video stream into a plurality of sections based on the scene boundary information. Each section comprises a plurality of temporally contiguous image frames. The encoder encodes each of the plurality of sections according to the target bit rate, providing adaptive bit rate control based on scenes. If a video quality bar is met at a lower bit-rate, there is no need to encode the same section at a higher bit-rate since the quality bar has already been met.

### PRIORITY CLAIM

This application claims priority to U.S. Provisional Patent Application No. 611437,193, entitled “Encoding of a Video Stream Based on Scenes with Different Parameters Used for Different Scenes”, which was filed on Jan. 28, 2011, and U.S. Provisional Patent Application No. 61/437,223, entitled “HTTP adaptive Bit Rate Control Based on Scenes”, which was filed on Jan. 28, 2011, the contents of which are expressly incorporated by reference herein.

### FIELD OF THE INVENTION

The present invention relates to a video and image compression technique and more particularly, to a video and image compression technique using adaptive bit rate control based on scenes.

### BACKGROUND

While video streaming continues to grow in popularity and usage among everyday users, there are several inherent limitations that need to be overcome. For example, users often want to watch a video over the Internet having only a limited bandwidth for obtaining that video stream. In instances, users might want to obtain the video stream over a mobile telephone connection or a home wireless connection. In some scenarios, users compensate for the lack of adequate bandwidth by spooling content (i.e., download content to local storage for eventual viewing). This method is rife with several disadvantages. First, the user is unable to have a real “run-time” experience—that is, the user is unable to view a program when he decides to watch it. Instead, he has to experience significant delays for the content to be spooled prior to viewing the program. Another disadvantage is in the availability of storage—either the provider or the user has to account for storage resources to ensure that the spooled content can be stored, even if for a short period of time, resulting in unnecessary utilization of expensive storage resources.

A video stream (typically containing an image portion and an audio portion) can require considerable bandwidth, especially at high resolution (e.g., HD videos). Audio typically requires much less bandwidth, but still sometimes needs to be taken into account. One streaming video approach is to heavily compress the video stream enabling rapid video delivery to allow a user to view content in run-time or substantially instantaneously (i.e., without experiencing substantial spooling delays). Typically, lossy compression (i.e., compression that is not entirely reversible) provides more compression than lossless compression, but heavy lossy compression provides an undesirable user experience,

In order to reduce the bandwidth required to transmit digital video signals, it is well known to use efficient digital video encoding where the data rate of a digital video signal may be substantially reduced (for the purpose of video data compression). In order to ensure interoperability, video encoding standards have played a key role in facilitating the adoption of digital video in many professional- and consumer applications. Most influential standards are traditionally developed by either the International Telecommunications Union (ITU-T) or the MPEG (Motion Pictures Experts Group 15 committee of the ISO/IEC (the International Organization for Standardization/the International Electrotechnical Committee. The ITU-T standards, known as recommendations, are typically aimed at real-time communications (e.g. videoconferencing), while most MPEG standards are optimized for storage (e.g. for Digital Versatile Disc (DVD>> and broadcast (e.g. for Digital Video Broadcast (OVB) standard).

At present, the majority of standardized video encoding algorithms are based on hybrid video encoding. Hybrid video encoding methods typically combine several different lossless and lossy compression schemes in order to achieve desired compression gain. Hybrid video encoding is also the basis for ITV-T standards (H.26x standards such as H.261, H.263) as well as ISO/IEC standards (MPEG-X standards such as MPEG-I, MPEG-2. and MPEG-4). The most recent and advanced video encoding standard is currently the standard denoted as H.264/MPEG-4 advanced video coding (AVC) which is a result of standardization efforts by joint video team (JVT), a joint team of ITV-T and ISO/IEC MPEG groups.

The H.264 standard employs the same principles of block-based motion compensated hybrid transform coding that are known from the established standards such as MPEG-2. The H.264 syntax is, therefore, organized as the usual hierarchy of headers, such as picture-, slice- and macro-block headers, and data, such as motion-vectors, block-transform coefficients, quantizer scale, etc. However,the H.264 standard separates the Video Coding Layer (VCL), which represents the content of the video data, and the Network Adaptation Layer (NAL), which formats data and provides header information.

Furthermore, H.264 allows for a much increased choice of encoding parameters. For example, it allows for a more elaborate partitioning and manipulation of 16×16 macro-blocks whereby e.g. motion compensation process can be performed on segmentations of a macro-block as small as 4×4 in size. Also, the selection process for motion compensated prediction of a sample block may involve a number of stored previously-decoded pictures, instead of only the adjacent pictures. Even with intra coding within a single frame, it is possible to form a prediction of a block using previously-decoded samples from the same frame. Also, the resulting prediction error following motion compensation may be transformed and quantized based on a 4×4 block size, instead of the traditional 8×8 size. Also an hi-loop deblocking filter is now mandatory.

The H.264 standard may be considered a superset of the H.262/MPEG-2 video encoding syntax in that it uses the same global structuring of video data while extending the number of possible coding decisions and parameters. A consequence of having a variety of coding decisions is that a good trade-off between the bit rate and picture quality may be achieved. However although it is commonly acknowledged that while the H.264 standard may significantly reduce typical artifacts of block-based coding, it can also accentuate other artifacts. The fact that H.264 allows for an increased number of possible values for various coding parameters thus results in an increased potential for improving the encoding process, but also results in increased sensitivity to the choice of video encoding parameters.

Similar to other standards, H.264 does not specify a normative procedure for selecting video encoding parameters, but describes through a reference implementation, a number of criteria that may be used to select video encoding parameters such as to achieve a suitable trade-off between coding efficiency, video quality and practicality of implementation. However, the described criteria may not always result in an optimal or suitable selection of coding parameters suitable for all kind of contents and applications. For example, the criteria may not result in selection of video encoding parameters optimal or desirable for the characteristics of the video signal or the criteria may be based on attaining characteristics of the encoded signal which are not appropriate for the current application.

It is known to encode video data using either constant bit rate (“CBR”) encoding or variable bit rate (“VBR”) encoding. In both cases, the number of bits per unit time is capped, i.e., the bit rate cannot exceed some threshold. Often, the bit rate is expressed in bits per second. CBR encoding is often just one type of VBR encoding with extra padding up to the constant bit rate (e.g., stuffing the bit stream with zeroes).

TCP/IP network, such as the Internet, is not a “bit stream” pipe, but a best effort network which the transmission capacity varies at any time. Encoding and transmitting videos using a CBR or VBR approach is not ideal in the best effort network. Some protocols have been designed to deliver video over the Rite net. A good example is HTTP Adaptive Bit Rate Video Streaming, wherein a video stream is segmented into files, which are delivered as files over HTTP connections. Each of those files contains a video sequence having a predetermined play time; and the bit rates may vary and the file size may vary. Thus, some files may be shorter than others.

Accordingly, an improved system for video encoding would be advantageous.

The foregoing examples of the related art and limitations related therewith are intended to be illustrative and not exclusive. Other limitations of the related art will become apparent upon a reading of the specification and a study of the drawings.

### SUMMARY

An encoder for encoding a video stream is described herein. The encoder receives an input video stream, scene boundary information that indicates positions in the input video stream where scene transitions occur and target bit rate for each scene. The encoder divides the input video stream into a plurality of sections based on the scene boundary information. Each section comprises a plurality of temporally contiguous image frames. The encoder encodes each of the plurality of scenes according to the target bit rate, providing adaptive bit rate control based on scenes.

This Summary is provided to introduce a selection of concepts in a simplified form that are further described below in the Detailed Description. This Summary is not intended to identify key features or essential features of the claimed subject matter,not is it intended to be used to limit the scope of the claimed subject matter.

### BRIEF DESCRIPTION OF THE DRAWINGS

One or more embodiments of the present invention are illustrated by way of example and are not limited by the figures of the accompanying drawings, in which like references indicate similar elements.

FIG. 1 illustrates an example of an encoder.

FIG. 2 illustrates steps of a sample method for encoding an input video stream.

FIG. 3 is a block diagram of a processing system that can be used to implement an encoder implementing certain techniques described herein.

### DETAILED DESCRIPTION

Various aspects of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description. Although the diagrams depict components as functionally separate, such depiction is merely for illustrative purposes. It will be apparent to those skilled in the art that the components portrayed in this figure may be arbitrarily combined or divided into separate components.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

References in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

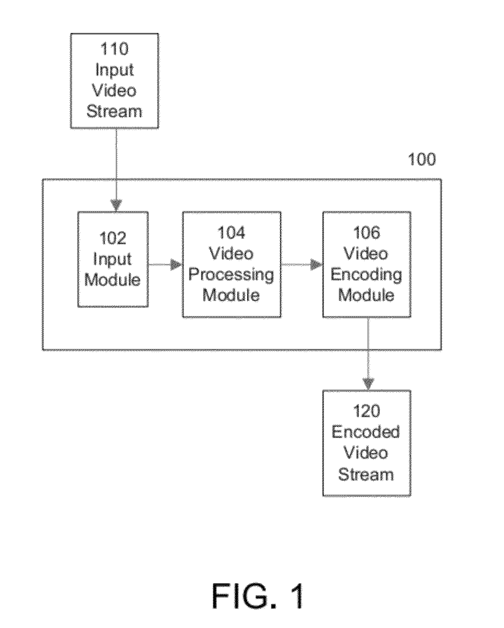

FIG. 1 illustrates an example of an encoder 100, according to one embodiment of the present invention. The encoder 100 receives an input video stream 110 and outputs an encoded video stream 120 that can be decoded at a decoder to recover, at least approximately, an instance of the input video stream 110. The encoder 100 comprises an input module 102, a video processing module 104, and a video encoding module 106. The encoder 100 may be implemented in hardware, software, or any suitable combination. The encoder 100 may include other components such as a video transmitting module, a parameter input module, memory for storing parameters, etc. The encoder 100 may perform other video processing functions not specifically described herein.

The input module 102 receives the input video stream 110. The input video stream 110 may take any suitable form, and may originate from any of a variety of suitable sources such as memory, or even from a live feed. The input module 102 further receives scene boundary information and target bit rate for each scene. The scene boundary information indicates positions in the input video stream where scene transitions occur.

The video processing module 104 analyzes an input video stream 110 and divides the video stream 110 into a plurality of sections for each of the plurality of scenes based on the scene boundary information. Each section comprises a plurality of temporally continuous image frames. In one embodiment, the video processing module further segments the input video stream into a plurality of files. Each file contains one or more sections. In another embodiment the position, resolution and time stamp or start frame number of each section of a video file is recorded into a the or database. A video encoding module encodes each section using the associated target bit rate or video quality with a bit-rate constrain. In one embodiment, the encoder further comprises a video transmitting module for transmitting the files over a network connection such as an HTTP connection.

In some embodiments, optical resolution of the video image frames are detected and utilized to determining the true or optimal scene video dimensions and the scene division. The optical resolution describes a resolution at which one or more video image frames can continuously resolve details. Due to the limitations of the capturing optics, recording media, original format, the optical resolution of a video image frame may be much less than the technical resolution of the video image frame. The video processing module may detect an optical resolution of the image frames within each section. A scene type may be determined based on the optical resolution of the image frames within the section. Moreover, the target bit rate of a section may be determined based on an optical resolution of the image frames within the section. For a certain section with a low optical resolution, the target bit rate can be lower because high bit rate does not help retaining the fidelity of the section. In some cases of electronic up-scalers, those up-scalers that convert a low resolution image to fit into a higher resolution video frame may also produce unwanted artifacts. This is especially true in old scaling technologies. By recovering the original resolution we will allow modern video processors to upscale the image in a more efficient way and avoid encoding unwanted artifacts that are not part of the original image,

The video encode module may encode each section using any encoding standards such as H.2641MPEG-4 AVC standard.

Each section, based on a different scene, may be encoded at a different level of perceptual qualities conveying different bit rates (i.e. 500 Kbps, 1 Mbps, 2 Mbps). In one embodiment, if an optical or video quality bar is met at a certain low bit-rate, i.e. 500 Kbps, then the encoding process may not be needed for higher bit-rates, avoiding the need to encode that scene at a higher bit-rate, i.e. 1 Mbps or 2 Mbps. See table 1. In the case of storing those scenes in a single file, the single file will only store the scenes needed to be encoded at a higher bit-rate. However in some cases, it may be necessary to storage in the high-bit-rate file (i.e. 1 Mbps) for all the scenes (For legacy in some old adaptive bit rate systems), in this particular case the section or segments to be stored will be the low-bit-rate ones, i.e. 500 Kbps instead of the high-bit rate ones. Therefore, storage space is saved. (But not as significant as not storing the scenes). See Table 2. In other case such for systems that doesn't support multiple resolutions in a single video file, the storage of the sections will occur in files with a determined frame size. To minimize the number of files at each resolution, some systems will limit the number of frames sizes such as SDTV, HD720p, HD1080p. See Table 3.

TABLE 1

| | | | Section | |
|---|---|---|---|---|
| Scene # | Frame End # | Scene Type | or index | Bit Rate (kbps) |
| 1 | 29 | Black Screen | 1 | No file or |
| | | | | session on |
| | | | | the single file |
| 2 | 673 | Default | 2 | 1,000 |
| 3 | 1369 | Fast Motion | 3 | 1,000 |
| 4 | 1373 | Low Interest | 4 | No file or |
| | | | | session on |
| | | | | the single file |
| 5 | 1386 | Fire/Water/ | 5 | 1,000 |
| | | Smoke | | |
| 6 | 1411 | Default | 6 | No file or |
| | | | | session on |
| | | | | the single file |
| 7 | 1419 | Default | 7 | No file or |
| | | | | session on |
| | | | | the single file |
| 8 | 1445 | Fast Motion | 8 | 1,000 |
| 9 | 1455 | Black Screen | 9 | No file or |
| | | | | session on |
| | | | | the single file |
| 10 | 1469 | Credits | 10 | No file or |
| | | | | session on |
| | | | | the single file |

TABLE 2

| | | | Section | |
|---|---|---|---|---|
| Scene # | Frame End # | Scene Type | or index | Bit Rate (kbps) |
| 1 | 29 | Black Screen | 1 | 5 |
| 2 | 673 | Default | 2 | 1,000 |
| 3 | 1369 | Fast Motion | 3 | 1,000 |
| 4 | 1373 | Low Interest | 4 | 600 |
| 5 | 1386 | Fire/Water/ | 5 | 1,000 |
| | | Smoke | | |
| 6 | 1411 | Default | 6 | 700 |
| 7 | 1419 | Default | 7 | 534 |
| 8 | 1445 | Fast Motion | 8 | 1,000 |
| 9 | 1455 | Black Screen | 9 | 5 |
| 10 | 1469 | Credits | 10 | 120 |

TABLE 3

| | | | | Image size of |
|---|---|---|---|---|
| | | | Section | the group |
| Scene # | Frame End # | Scene Type | or index | width × height |
| 1 | 29 | Black Screen | 1 | 320 × 240 |
| 2 | 673 | Default | 2 | 720 × 480 |
| 3 | 1369 | Fast Motion | 3 | 320 × 480 |
| 4 | 1373 | High Interest | 4 | 1280 × 720 |
| 5 | 1386 | Fire/Water/ | 5 | 720 × 480 |
| | | Smoke | | |
| 6 | 1411 | Default | 6 | 720 × 480 |
| 7 | 1419 | Default | 7 | 720 × 480 |
| 8 | 1445 | Fast Motion | 8 | 320 × 480 |
| 9 | 1455 | Black Screen | 9 | 320 × 480 |
| 10 | 1469 | Credits | 10 | 720 × 480 |

Each section, based on a different scene, may be encoded at a different level of perceptual quality and a different bit rate. In one embodiment, the encoder reads an input video stream and a database or other listing of scenes, and then partitions the video stream into sections based on the information of scenes. An example data structure for a listing of scenes in a video is shown in Table 4. In some embodiments, the data structure may be stored in a computer readable memory or a database and be accessible by the encoder.

TABLE 4

| | | | Section | |
|---|---|---|---|---|
| Scene # | Frame End # | Scene Type | or index | Bit Rate (kbps) |
| 1 | 29 | Black Screen | 1 | 5 |
| 2 | 673 | Default | 2 | 1,000 |
| 3 | 1369 | Fast Motion | 3 | 1,500 |
| 4 | 1373 | Low Interest | 4 | 600 |
| 5 | 1386 | Fire/Water/ | 5 | 1,200 |
| | | Smoke | | |
| 6 | 1411 | Default | 6 | 700 |
| 7 | 1419 | Default | 7 | 534 |
| 8 | 1445 | Fast Motion | 8 | 1,300 |
| 9 | 1455 | Black Screen | 9 | 5 |
| 10 | 1469 | Credits | 10 | 120 |

Different types of scenes may be utilized for the listing of scenes, such as “fast motion”, “static”, “talking head”, “text”, “mostly black images”, “short scene of five frames or less”, “black screen”, “low interest”, “file” “water”, “smoke”, “credits”, “blur”, “out of focus”, “image having a lower resolution than the image container size”, etc. In some embodiments, some scene sequences might be “miscellaneous”, “unknown” or “default” scene types assigned to such scenes.

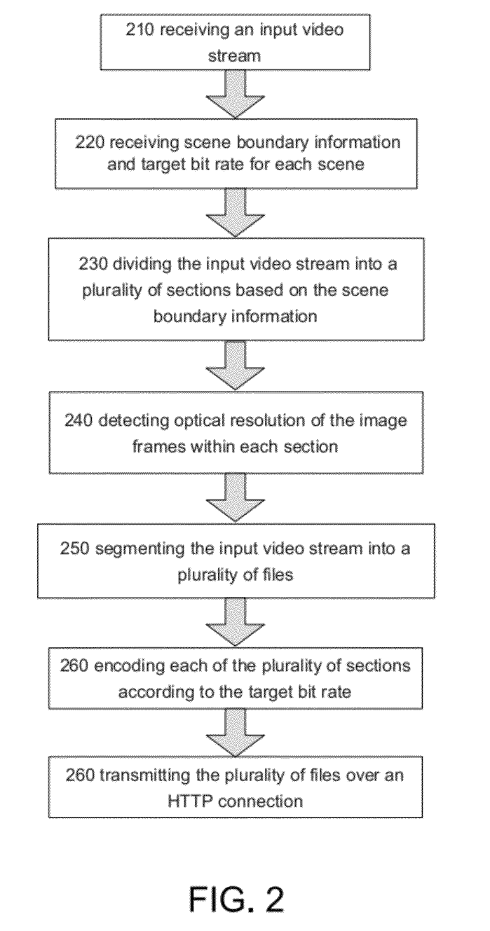

FIG. 2 illustrates steps of a method 200 for encoding an input video stream. The method 200 encodes the input video stream to an encoded video bit stream that can be decoded at a decoder to recover, at least approximately, an instance of the input video stream. At step 210, the method receives an input video stream to be encoded. At step 220, the method receives scene boundary information that indicates positions in the input video stream where scene transitions occur and target bit rate for each scene. At step 230, the input video stream is divided into a plurality of sections based on the scene boundary information, each section comprising a plurality of temporally contiguous image frames. Then, at step 240, the method detects optical resolution of the image frames within each section. At step 250, the method segments the input video stream into a plurality of files, each file containing one or more sections. At step 260, each of the plurality of sections is encoded according to the target bit rate. Then at step 270, the method transmits the plurality of files over an HTTP connection.

The input video stream typically includes multiple image frames. Each image frame can typically be identified based on a distinct “time position” in the input video stream. In embodiments, the input video stream can be a stream that is made available to the encoder in parts or discrete segments. In such instances, the encoder outputs the encoded video bit stream (for example, to a final consumer device such as a HDTV) as a stream on a rolling basis before even receiving the entire input video stream.

In embodiments, the input video stream and the encoded video bit stream are stored as a sequence of streams. Here, the encoding may be performed ahead of time and the encoded video streams may then be streamed to a consumer device at a later time. Here, the encoding is completely performed on the entire video stream prior to being streamed over to the consumer device. It is understood that other examples of pre, post, or “in-line” encoding of video streams, or a combination thereof, as may be contemplated by a person of ordinary skill in the art, are also contemplated in conjunction with the techniques introduced herein.

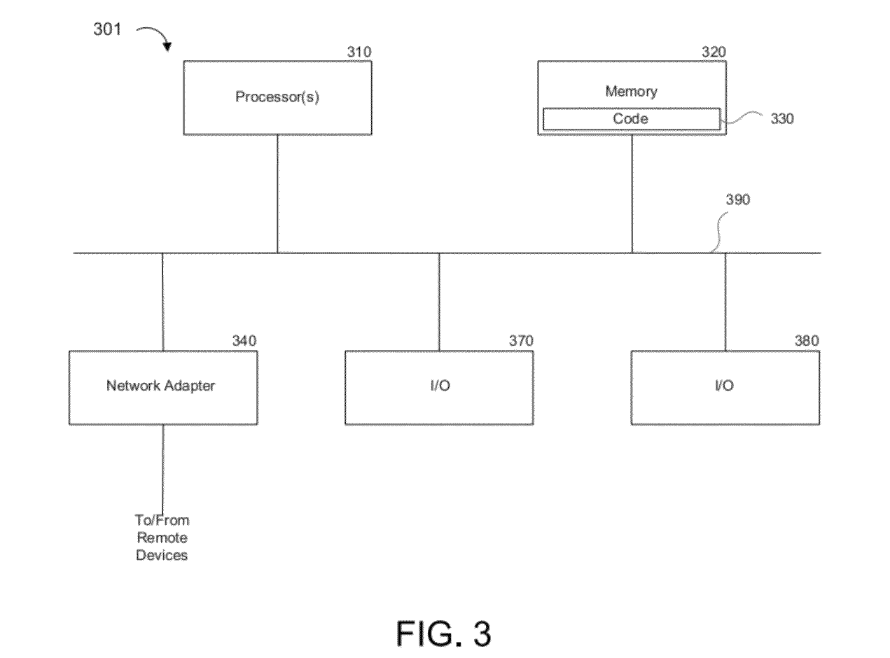

FIG. 3 is a block diagram of a processing system that can be used to implement any of the techniques described above, such as an encoder. Note that in certain embodiments, at least some of the components illustrated in FIG. 3 may be distributed between two or more physically separate but connected computing platforms or boxes. The processing can represent a conventional server-class computer, PC, mobile communication device (e.g., smartphone), or any other known or conventional processing/communication device.

The processing system 301 shown in FIG. 3 includes one or more processors 310, i.e. a central processing unit (CPU), memory 320, at least one communication device 340 such as an Ethernet adapter and/or wireless communication subsystem (e.g., cellular, WiFi. Bluetooth or the like), and one or more I/O devices 370, 380, all coupled to each other through an interconnect 390.

The processor(s) 310 control(s) the operation of the computer system 301 and may be or include one or more programmable general-purpose or special-purpose microprocessors, microcontrollers, application specific integrated circuits (ASICs), programmable logic devices (PLDs), or a combination of such devices. The interconnect 390 can include one or more buses, direct connections and/or other types of physical connections, and may include various bridges, controllers and/or adapters such as are well-known in the art. The interconnect 390 further may include a “system bus”, which may be connected through one or more adapters to one or more expansion buses, such as a form of Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”).

The memory 320 may be or include one or more memory devices of one or more types, such as read-only memory (ROM), random access memory (RAM), flash memory, disk drives, etc. The network adapter 340 is a device suitable for enabling the processing system 301 to communicate data with a remote processing system over a communication link, and may be, for example, a conventional telephone modem, a wireless modem, a Digital Subscriber Line (DSL) modem, a cable modem, a radio transceiver, a satellite transceiver, an Ethernet adapter, or the like. The 110 devices 370, 380 may include, for example, one or more devices such as; a pointing device such as a mouse, trackball, joystick, touchpad, or the like; a keyboard; a microphone with speech recognition interface; audio speakers; a display device; etc. Note, however, that such I/O devices may be unnecessary in a system that operates exclusively as a server and provides no direct user interface, as is the case with the server in at least some embodiments. Other variations upon the illustrated set of components can be implemented in a manner consistent with the invention.

Software and/or firmware 330 to program the processor(s) 310 to carry out actions described above may be stored in memory 320. In certain embodiments, such software or firmware may be initially provided to the computer system 301 by downloading it from a remote system through the computer system 301 (e.g., via network adapter 340).

The techniques introduced above can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc,

The term “logic”, as used herein, can include, for example, programmable circuitry programmed with specific software and/or firmware, special-purpose hardwired circuitry, or a combination thereof.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

The teachings of the invention provided herein can be applied to other systems, not necessarily the system described above. The elements and acts of the various embodiments described above can be combined to provide further embodiments.

While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification unless the above Detailed Description section explicitly defines such terms. Accordingly, the actual scope of the invention encompasses not only the disclosed embodiments, but also all equivalent ways of practicing or implementing the invention under the claims.

What is claimed is:

1. A method for encoding a video stream using scene types, the method comprising:
receiving an input video stream;
receiving scene boundary information that indicates positions in the input video stream where scene transitions occur and target bit rate for each scene;
dividing the input video stream into a plurality of sections based on the scene boundary information, each section comprising a plurality of temporally contiguous image frames; and
encoding each of the plurality of sections according to the target bit.

2. The method for encoding a video stream as recited in claim 1, further comprising:
receiving maximum container size for each scene.

3. The method for encoding a video stream as recited in claim 2, wherein the step of encoding comprising encoding each of the plurality of section according to the target bit rate and the maximum container size.

4. The method for encoding a video stream as recited in claim 1, further comprising:
segmenting the input video stream into a plurality of files, each file containing one or more sections.

5. The method for encoding a video stream as recited in claim 1, further comprising:
segmenting the input video stream into a database and a single video file, each file containing none or one or more sections.

6. The method for encoding a video stream as recited in claim 1, further comprising:
transmitting the plurality of files over an HTTP connection.

7. The method for encoding a video stream as recited in claim 1, further comprising:
detecting optimal optical resolution of the image frames within each section.

8. The method for encoding a video stream as recited in claim 1, wherein at least one of the scene types is determined based on an optical resolution of the image frames within the section.

9. The method for encoding a video stream as recited in claim 1, wherein at least one of the target bit rate of the sections is determined based on an optical resolution of the image frames within the section.

10. The method for encoding a video stream as recited in cam wherein at least one of the video image size of the sections is determined based on the closest optical resolution of the image frames within the section.

11. The method for encoding a video stream as recited in cam wherein the step of encoding comprising encoding each of the plurality of sections according to the target bit rate based on an H.264/MPEG-4 AVC standard.

12. The method for encoding a video stream as recited in claim 1, wherein a given scene type includes one or more of:
a fast motion scene-type;
a static scene-type;
a talking head;
a text;
a mostly black images;
a short scene;
a low interest scene-type;
a fire scene-type;
a water scene-type;
a smoke scene-type;
a credits scene-type;
a blur scene-type;
a out of focus scene-type;
a image having a lower resolution than the image container size scene-type;
a miscellaneous; or
a default.

13. A video encoding apparatus for encoding a video stream using scene types, the apparatus comprising:
an input module for receiving an input video stream;
the input module receiving scene boundary information that indicates positions in the input video stream where scene transitions occur and target bit rate for each scene;
a video processing module to divide the input video stream into a plurality of sections based on the scene boundary information, each section comprising a plurality of temporally contiguous image frames; and
a video encoding module to encode each of the plurality of sections according to the target bit rate.

14. The video encoding apparatus as recited in claim 1, wherein the input module further receives optic I image size for each scene.

15. The video encoding apparatus as recited in claim 14, wherein the video encoding module further encode each of the plurality of section according to the optical image size.

16. The video encoding apparatus as recited in claim 13, wherein the video processing module further segments the input video stream into a plurality of files, and each the contains one or more sections.

17. The video encoding apparatus as recited in claim 13, wherein the video stream is encoded as a single the accompanied with a the containing the position of each segment, start frame, time stamp and resolution.

18. The video encoding apparatus as recited in claim 13, further comprising:
a video transmitting module for transmitting the plurality of files over an HTTP connection.

19. The video encoding apparatus as recited in claim 13, wherein the video processing module further detects an optical resolution of the image frames within each section.

20. The video encoding apparatus as recited in claim 13, wherein at least one of the scene types is determined based on an optical resolution of the image frames within the section.

21. The video encoding apparatus as recited in claim 13, wherein at least one of the target bit rate of the sections is determined based on an optical resolution of the image frames within the section.

22. The video encoding apparatus as recited in claim 13, wherein at least one of the video quality bar of the sections is determined based on an optical resolution of the image frames within the section.

23. The video encoding apparatus as recited in claim 13, wherein the video encoding module encodes each of the plurality of sections according to the target bit rate based on an H.264/MPEG-4 AVC standard.

24. The video encoding apparatus as recited in claim 13, wherein a given scene type assigned by the video processing mods includes one or more of:
a fast motion scene-type;
a static scene-type;
a talking head;
a text;
a mostly black images;
a short scene;
a low interest scene-type;
a fire scene-type;
a water scene-type;
a smoke scene-type;
a credits scene-type;
a blur scene-type;
a out of focus scene-type;
a image having a lower resolution than the image container size scene-type;
a miscellaneous; or
a default.
